(19) United States
(12) Patent Application Publication
(10) Pub. No.: US 2019/0118502 A1
(43) Pub. Date: Apr. 25, 2019

(54) FLUID LINE FOR CONDUCTING A FLUID

(71) Applicant: Veritas AG, Gelnhausen (DE)

(72) Inventors: Michael Rosemann, Hasselroth (DE); Matthias Knopp, Bruchkoebel (DE)

(21) Appl. No.: 16/163,905

(22) Filed: Oct. 18, 2018

(30) Foreign Application Priority Data
Oct. 20, 2017 (DE) 102017124606.1

(51) Int. Cl. B32B 1/08; B32B 25/04; B32B 25/10; B32B 5/02; B32B 7/12; F02M 35/10; F16L 11/08

(52) U.S. Cl. CPC B32B 1/08; B32B 25/042; B32B 25/10; B32B 5/024; B32B 5/026; B32B 2605/00; F02M 35/10321; F16L 11/085; B32B 2262/0261; B32B 2262/0276; B32B 2597/00; B32B 7/12

(57) ABSTRACT

The present disclosure relates to a fluid line for conducting a fluid. The fluid line may include an external layer including a crosslinked chlorinated polyethylene (CPE); a reinforcement system arranged within the external layer, and a barrier layer arranged within the reinforcement system and configured to delimit an internal passage of the fluid line configured to conduct the fluid, where the barrier layer is configured to reduce diffusion of the fluid through the barrier layer.

### CROSS-REFERENCE TO RELATED APPLICATIONS

This application claims priority to German patent application No. 10 2017 124 606.1, entitled “FLUIDLEITUNG ZUM LEITEN EINES FLUIDS”, and filed on Oct. 20, 2017 by the Applicant of this application. The entire disclosure of the German application is incorporated herein, by reference for all purposes.

### BACKGROUND

The present disclosure relates to a fluid line for conducting a fluid, in particular to a fluid line in a vehicle for conducting a fluid.

Many fluid lines are used in a vehicle in order to transport gases or liquids. Charge air is conducted through a fluid line configured as charge-air line in order to supply charge air to an internal combustion engine of a motor vehicle during operation. An operating liquid, in particular engine oil, is conducted through a fluid line configured as operating-liquid line in order to operate an internal combustion engine of a motor vehicle.

DE 10 2009 026 254 A1 discloses a hose with an internal layer made of an aminically crosslinked rubber mixture with solvent-resistant properties, a tie layer made of a peroxidically crosslinked rubber mixture, a reinforcement layer and an external layer.

DE 10 2013 103 759 A1 discloses a hose with an internal layer as barrier layer and art external layer made of a crosslinked rubber mixture.

U.S. Pat. No. 8,449,961 B2 discloses a hose with an internal layer made of elastomer, an intermediate layer made of elastomer, a reinforcement structure and an external layer made of elastomer.

EP 1 546 595 B1 discloses a pipe which in particular is intended for a suction air-intake circulation system in an engine of a motor vehicle, where the pipe comprises an interior layer, a flexible exterior layer and an intermediate layer, where the intermediate layer facilitates adhesion between the interior layer and the exterior layer.

### SUMMARY

The object underlying the disclosure is to provide, for a motor vehicle, a fluid line which has advantageous chemical resistance and mechanical stability.

This object is achieved via subject matter with the features according to the independent claims. Advantageous examples of the disclosure are provided by the figures, the description and the dependent claims.

According to a first aspect of the disclosure, the object is achieved via a fluid line for conducting a fluid, with an external layer which comprises a crosslinked chlorinated polyethylene (CPE); a reinforcement system arranged within the external layer, and a barrier layer arranged within the reinforcement system and delimiting an internal passage of the fluid line for conducting the fluid, where the barrier layer is configured to reduce diffusion of the fluid through the barrier layer.

An example of a technical advantage thus achieved is that it is possible to provide a fluid line which exhibits effective chemical resistance to fluid conducted through the internal passage of the fluid line, and which exhibits effective mechanical stability in relation to exterior effects.

The barrier layer delimits the fluid line in relation to the internal passage of the fluid line, and reduces diffusion of the fluid through the barrier layer. It is thus possible to ensure that even chemically reactive fluids conducted through the fluid line do not damage the fluid line, and it is thus possible to ensure effective conducting of fluids, e.g. charge air comprising acids or condensates, and also engine oil, through the fluid line.

The reinforcement system of the fluid line ensures that, even when high-pressure fluid is conducted through the fluid line, the structural integrity of the fluid line is not impaired. This is ensured in that the reinforcement system can provide effective absorption of pressure-related forces acting on the fluid line.

The external layer delimits the fluid line in relation to an external region of the fluid line, and protects the barrier layer situated thereunder, and the reinforcement system situated thereunder, from mechanical and/or chemical damage, e.g. in the event that the fluid line comes into contact with other components in the restricted installation space in an engine compartment of a motor vehicle.

The external layer consists in this case of crosslinks chlorinated polyethylene (CPE). The crosslinked chlorinated polyethylene (CPE) in this case in particular ensures effective chemical resistance of the external layer of the fluid line in relation to engine oil; external layers conventionally used, made of ethylene-propylene-diene rubber (EPDM), cannot ensure this to the same extent.

The fluid line is configured in this case as dimensionally stable moulded hose which in particular has a two-dimensionally or three-dimensionally curved shape, thus permitting effective installation of the fluid line in a restricted installation space.

The fluid line according to the present disclosure therefore ensures low-cost construction of a fluid line which has advantageous chemical resistance and mechanical stability.

In an advantageous example, the fluid line comprises an intermediate layer arranged between the barrier layer and the reinforcement system.

An example of a technical advantage thus achieved is that the intermediate layer reliably provides an effective adhesive bond between the barrier layer and the reinforcement system within the fluid line, thus particularly advantageously allowing the structural integrity of the fluid line to be ensured during the operation of the fluid line.

In an advantageous example, the intermediate layer comprises a crosslinked chlorinated polyethylene (CPE).

An example of a technical advantage thus achieved is that the crosslinked chlorinated polyethylene (CPE) ensures that the intermediate layer can provide an effective adhesive bond between the barrier layer and the reinforcement system. In this case the crosslinked chlorinated polyethylene (CPE) has particularly advantageous structural properties.

In an advantageous example, the barrier layer comprises an aminically crosslinked ethylene-acrylate rubber (AEM) and/or an aminically crosslinked polyacrylate rubber (ACM), where the aminically crosslinked ethylene-acrylate rubber (AEM) and/or the aminically crosslinked polyacrylate rubber (ACM) comprises a diamine and a basic activator.

An example of a technical advantage thus achieved is that the aminically crosslinked ethylene-acrylate rubber (AEM) and/or the aminically crosslinked polyacrylate rubber (ACM) can effectively reduce diffusion of many fluids through the barrier layer and thus reliably provide particularly advantageous properties of the barrier layer. The addition of the diamine and of the basic activator can ensure effective aminic crosslinking in the barrier layer. The proportion of the diamine in the barrier layer is in particular from 0.3% by weight to 2.1% by weight, in particular from 0.4% by weight to 1.5% by weight, in particular from 0.5% by weight to 1.0% by weight. The proportion of the basic activator in the barrier layer is in particular from 0.5% by weight to 3.5% by weight, in particular from 0.5% by weight to 2.4% by weight, in particular from 0.7% by weight to 2.0% by weight.

In an advantageous example, the diamine comprises hexamethylenediamine (HMD), hexamethylenediamine carbamate (HMDC) and/or 2,2-bis[4-(4-aminophenoxy)phenyl]propene, and/or the basic activator comprises diphenylguanidine (DPG) and/or diazabicycloundecene (DBU).

An example of a technical advantage thus achieved is that the addition of hexamethylenediamine (HMD), hexamethylenediamine carbamate (HMDC) and/or 2,2-bis[4-(4-aminophenoxy)phenyl]propene as diamine and, respectively, diphenylguanidine (DPG) and/or diazabicycloundecene (DBU) as basic activator during the production of the barrier layer ensures that effective crosslinking of the aminically crosslinked ethylene-acrylate rubber (AEM) and/or of the aminically crosslinked polyacrylate rubber (ACM) is achieved.

In an advantageous example, the barrier layer comprises a peroxidically crosslinked ethylene-acrylate rubber (AEM) and/or a peroxidically crosslinked polyacrylate rubber (ACM), where the peroxidically crosslinked ethylene-acrylate rubber (AEM) and/or the peroxidically crosslinked polyacrylate rubber (ACM) comprises a peroxide derivative, a co-activator, and/or an acid acceptor, where the peroxide derivative in particular comprises an alkyl-aralkyl peroxide derivative, a diaralkyl peroxide derivative, a peroxyketal derivative and/or a peroxyester derivative, where the co-activator in particular comprises triallyl cyanurate (TAC), triallyl isocyanurate (TAIC), trimethylolpropane trimethacrylate (TRIM), dimethyl acrylate, trimethyl acrylate, triazine, and/or bismaleimide, and/or where the acid acceptor in particular comprises epoxy resins, epoxidized oils, magnesium oxide and/or hydrotalcite.

An example of a technical advantage thus achieved is that the peroxidically crosslinked ethylene-acrylate rubber (AEM) and/or the peroxidically crosslinked polyacrylate rubber (ACM) effectively reduce(s) the diffusion of many fluids through the barrier layer and therefore reliably provide(s) particularly advantageous properties of the barrier layer. Addition of the peroxide derivative, of the co-activator and of the acid acceptor can ensure effective peroxidic crosslinking in the barrier layer. The proportion of the peroxide derivative in the barrier layer is in particular from 0.5% by weight to 6.0% by weight, in particular from 0.8% by weight to 4.0% by weight, in particular from 1.0% by weight to 2.0% by weight. The proportion of the co-activator in the barrier layer is in particular from 0.1% by weight to 10.0% by weight, in particular from 0.5% by weight to 5.0% by weight, in particular from 1.0% by weight, to 2.0% by weight.

In an advantageous example, the external layer and/or the intermediate layer made of crosslinked chlorinated polyethylene (CPE) comprises a thiazole derivative, a fatty acid amide derivative and/or an acid acceptor, where the acid acceptor in particular comprises epoxy resins, epoxidized oils, magnesium oxide and/or hydrotalcite.

An example of a technical advantage thus achieved is that a thiazole-crosslinked chlorinated polyethylene (CPE) reliably provides particularly advantageous properties of the external layer and/or of the intermediate layer. The proportion of the thiazole derivative in the external layer and/or the intermediate layer is in particular from 0.1% by weight to 5.0% by weight, in particular from 0.5% by weight to 3.0% by weight, in particular from 0.7% by weight to 1.5% by weight. The proportion of the fatty acid amide derivative in the external layer and/or the intermediate layer is in particular from 0.1% by weight to 5.0% by weight, in particular from 0.5% by weight to 3.0% by weight, in particular from 0.7% by weight to 1.5% by weight.

In an advantageous example, the external layer and/or the intermediate layer comprises a peroxidically crosslinked chlorinated polyethylene (CPE), where the peroxidically crosslinked chlorinated polyethylene (CPE) comprises a peroxide derivative, a co-activator, and/or an acid acceptor, where the peroxide derivative in particular comprises an alkyl-aralkyl peroxide derivative, a diaralkyl peroxide derivative, a peroxyketal derivative and/or a peroxyester derivative, where the co-activator in particular comprises triallyl cyanurate (TAC), triallyl isocyanurate (TAIC), trimethylolpropane trimethacrylate (TRIM), dimethyl acrylate, trimethyl acrylate, triazine, and/or bismaleimide, and/or where the acid acceptor in particular comprises epoxy resins, epoxidized oils, magnesium oxide and/or hydrotalcite.

An example of a technical advantage thus achieved is that peroxidically crosslinked chlorinated polyethylene (CPE) reliably provides particularly advantageous properties of the external layer and/or of the intermediate layer. Addition of the peroxide derivative, of the co-activator and of the acid acceptor can ensure effective peroxidic crosslinking in the external layer and/or the intermediate layer. The proportion of the peroxide derivative in the barrier layer is in particular from 0.5% by weight to 6.0% by weight, in particular from 0.8% by weight to 4.0% by weight, in particular from 1.0% by weight to 2.0% by weight. The proportion of the co-activator in the barrier layer is in particular from 0.1% by weight to 10.0% by weight, in particular from 0.5% by weight to 5.0% by weight, in particular from 1.0% by weight to 2.0% by weight.

In an advantageous example, the reinforcement system comprises aromatic or aliphatic polyamide fibres, polyoxadiazole fibres, polyester fibres, aramid fibres, in particular meta-aramid fibres and/or para-aramid fibres, polyimide fibres, polyvinyl acetal fibres, polyetheretherketone fibres, or a mixture thereof.

An example of a technical advantage thus achieved is that the fibres mentioned have high heat resistance and high pressure resistance, and can be advantageously processed to give deformable reinforcement systems. In particular, polyester fibres can be used advantageously in the reinforcement system because they have advantageous mechanical and chemical properties.

In an advantageous example, the reinforcement system is configured as a single-ply or multiple-ply reinforcement system, where the reinforcement system in particular comprises a woven fabric, formed-loop knitted fabric and/or drawn-loop knitted fabric.

An example of a technical advantage thus achieved is that a correspondingly configured reinforcement system can provide particularly effective absorption of loads related to pressure.

In an advantageous example, the fluid hose is configured as a dimensionally stable moulded hose, where the moulded hose in particular has a two-dimensionally or three-dimensionally curved shape.

An example of a technical advantage thus achieved is that it is possible to install a moulded hose particularly advantageously in a restricted installation space, e.g. in an engine compartment of a motor vehicle. In this case, the two-dimensional or three-dimensional curvature of the moulded hose can be adjusted so that it is appropriate for the geometric restrictions in the installation space. The moulded hose can, at least in sections, have resilient properties, by virtue of which the moulded hose can be bent to some extent during installation in order to ensure effective installation, but after installation the moulded hose returns to its original shape, and the moulded hose therefore exhibits effective dimensional stability. In particular, the two-dimensionally or three-dimensionally curved dimensionally stable moulded hose has a plurality of bends.

In an advantageous example, the dimensionally stable moulded hose has, on an internal side of the barrier layer, the said side being that which faces towards the internal passage of the fluid line, a thickening bead running around the internal side of the barrier layer.

An example of a technical advantage thus achieved is that the thickening bead running around the internal side of the barrier layer ensures particularly effective mechanical stabilization of the dimensionally stable moulded hose. In this case the thickening bead can run around, in particular, some sections of or all sections of, the internal side of the barrier layer. In this case there can be, arranged on the internal side of the barrier layer, a large number of thickening beads which run around some sections of, or all sections of, the internal side of the barrier layer.

In an advantageous example, the fluid line is an injection moulding or an extruded moulding.

An example of a technical advantage thus achieved is that an injection moulding or extruded moulding provides particularly advantageous manufacture of the fluid line and moreover ensures effective arrangement and stable bonding of the individual layers within the fluid line.

In an advantageous example, the fluid line is configured as an operating-liquid line configured to conduct operating liquids, in particular engine oil, in a vehicle, or the fluid line is configured as a charge-air line configured to conduct charge air, in particular charge air comprising acids, condensates, and/or engine oil, in a vehicle.

An example of a technical advantage thus achieved is that the fluid line has effective chemical resistance and mechanical stability in relation to a large number of different fluids.

In an advantageous example, the internal diameter of the fluid line is from 20 mm to 100 mm, in particular from 30 mm to 85 mm.

An example of a technical advantage thus achieved is that the internal diameter of the fluid line provides an adequately large volume of the internal passage, and it is therefore possible to conduct an adequate quantity of fluid through the internal passage of the fluid line.

In an advantageous example, the wall thickness of the fluid line is from 2 mm to 7 mm, in particular from 3.5 mm to 5.0 mm.

An example of a technical advantage thus achieved is that the wall thickness provides adequate stability of the fluid line, and it is therefore also possible to effectively install the fluid line in a restricted installation space.

According to a second aspect of the disclosure, the object is achieved via a process for producing a fluid line for conducting a fluid, comprising the following steps: extruding a barrier layer which delimits an internal passage of the fluid line for conducting the fluid, where the barrier layer is configured to reduce diffusion of the fluid through the barrier layer; arranging a reinforcement system on the barrier layer; and extruding an external layer on the reinforcement system, where the external layer comprises a crosslinked chlorinated polyethylene (CPE).

An example of a technical advantage thus achieved is that the process ensures the advantageous production of a three-ply fluid line with effective chemical resistance and mechanical stability.

In an advantageous example, the process comprises the following steps: extruding a barrier layer delimiting an internal passage of the fluid line for conducting the fluid, where the barrier layer is configured to reduce diffusion of the fluid through the barrier layer, extruding an intermediate layer on the barrier layer, arranging a reinforcement system on the intermediate layer, and extruding an external layer on the reinforcement system, where the external layer comprises a crosslinked chlorinated polyethylene (CPE), and where in particular the extrusion of the barrier layer and the extrusion of the intermediate layer are carried out as separate extrusion steps or together as a single co-extrusion step.

An example of a technical advantage thus achieved is that the process ensures the advantageous production of a four-ply fluid line with effective chemical resistance and mechanical stability.

### BRIEF DESCRIPTION OF THE DRAWINGS

Examples of the present disclosure are depicted in the drawings and are described in more detail hereinafter.

FIG. 1 shows a perspective view of a fluid line according to a first example;

FIG. 2 shows a perspective view of a fluid line according to a second example; and

FIG. 3 shows a schematic diagram of a process for producing a fluid line.

### DETAILED DESCRIPTION

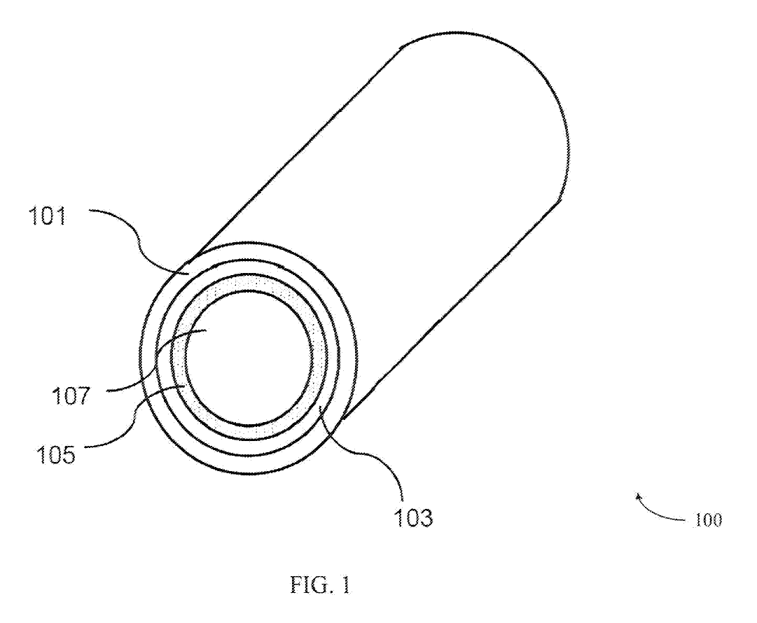

FIG. 1 is a perspective view of a fluid line 100. The fluid line 100 comprises in particular a fluid line 100 for vehicles, in particular for motor vehicles with an internal combustion engine.

Motor vehicles with internal combustion engines have fluid lines 100 which in particular comprise a charge-air line configured to supply charge air to the internal combustion engine, or which in particular comprise a liquid line in a liquid circulation system of the motor vehicle, where in this case liquid conducted through the fluid line 100, in particular engine oil, is supplied to the internal combustion engine in order to ensure operation of the internal combustion engine.

The charge air conducted through a charge-air line can also comprise, alongside the charge air, contaminants such as engine oil, fuel vapours, fuel condensates, exhaust gases, blow-by gases, and/or acids. Fluid lines 100 for conducting charge air and/or liquid must therefore have adequate chemical resistance to the fluid conducted. The corresponding fluid lines 100 must also have adequate mechanical stability, so that they are not damaged by the high-temperature and high-pressure fluids conducted. The corresponding fluid lines 100 must moreover be amenable to installation with small bending radii in the restricted installation space of the engine compartment of the motor vehicle, and must therefore have properties permitting dynamic deformation.

The fluid line 100 is in this case configured as a dimensionally stable moulded hose which in particular has a two-dimensionally or three-dimensionally curved shape, so that the moulded hose can be installed particularly advantageously in a restricted installation space of an engine compartment of a motor vehicle. During the production of a fluid line 100 configured as moulded hose, a hose preform is bent into the desired shape of the moulded hose. The hose preform, is then fixed in the desired shape, e.g. via vulcanization, so that a dimensionally stable moulded hose is obtained. The dimensionally stable moulded hose has a certain flexibility, but when the moulded hose is subjected to bending or twisting it returns to the original shape. A two-dimensionally or three-dimensionally curved dimensionally stable moulded hose in particular has a plurality of bends.

The fluid line 100 depicted in FIG. 1 has an external layer 101 configured to provide effective protection of the fluid line 100 from exterior mechanical and chemical influences. The external layer 101 in this case comprises a crosslinked chlorinated polyethylene (CPE) which exhibits effective oil resistance, and therefore has advantageous properties in comparison with conventionally used ethylene-propylene-diene rubber (EPDM).

The crosslinked chlorinated polyethylene (CPE) of the external layer 101 can in this case comprise a thiazole derivative, a fatty acid amide derivative and/or an acid acceptor, where the acid acceptor in particular comprises epoxy resins, epoxidized oils, magnesium oxide and/or hydrotalcite, in order to ensure effective crosslinking of the crosslinked chlorinated polyethylene (CPE).

Alternatively, the crosslinked chlorinated polyethylene (CPE) of the external layer 101 can comprise a peroxidically crosslinked chlorinated polyethylene (CPE), where the peroxidically crosslinked chlorinated polyethylene (CPE) comprises a peroxide derivative, a co-activator, and/or an acid acceptor, in order to ensure effective crosslinking of the crosslinked chlorinated polyethylene (CPE). The peroxide derivative can in particular comprise an alkyl-aralkyl peroxide derivative, a diaralkyl peroxide derivative, a peroxyketal derivative and/or a peroxyester derivative. The co-activator can in particular comprise triallyl cyanurate (TAC), triallyl isocyanurate (TAIC), trimethylolpropane trimethacrylate (TRIM), dimethyl acrylate, trimethyl acrylate, triazine, and/or bismaleimide. The acid acceptor can in particular comprise epoxy resins, epoxidized oils, magnesium oxide and/or hydrotalcite.

The external layer 101 can provide reliable mechanical protection of the fluid line 100, because mechanical loads acting on the external layer 101 during contact with the external layer 101 of the fluid line 100 with other components in the vehicle can be particularly effectively absorbed by the external layer 101, and damage to the layers situated within the external layer 101 can thus be prevented.

The external layer 101 of the fluid line 100 therefore reliably provides particularly advantageous chemical and mechanical protection of the fluid line 100.

Arranged within the external layer 101, there is a reinforcement system 103 of the fluid line 100; the said reinforcement system reliably provides effective stability of the fluid line 100 when high-pressure fluid is conducted through the fluid line 100.

The reinforcement system 103 comprises in particular aromatic or aliphatic polyamide fibres, polyoxadiazole fibres, polyester fibres, aramid fibres, in particular meta-aramid fibres and/or para-aramid fibres, polyimide fibres, polyvinyl acetal fibres, polyetheretherketone fibres, or a mixture thereof.

The reinforcement system 103 can in this case in particular be configured as a single-ply or multiple-ply reinforcement system 103. The reinforcement system 103 can in this case in particular comprise a woven fabric, formed-loop knitted fabric and/or drawn-loop knitted fabric.

Arranged within the reinforcement system 103 of the fluid line 100, there is a barrier layer 105 which delimits an internal passage 107 of the fluid line 100 for conducting a fluid. The barrier layer 105 is in this case configured to reduce diffusion of the fluid through the barrier layer 105.

The barrier layer 105 comprises in particular an aminically crosslinked ethylene-acrylate rubber (AEM) and/or an aminically crosslinked polyacrylate rubber (ACM), or alternatively comprises a peroxidically crosslinked ethylene-acrylate rubber (AEM) and/or a peroxidically crosslinked polyacrylate rubber (ACM).

In order to achieve effective crosslinking within the aminically crosslinked AEM rubber and/or ACM rubber of the barrier layer 105 and, respectively, effective crosslinking within the crosslinked CPE rubber of the external layer 101, different crosslinking systems are used for the crosslinking of the barrier layer 105 and, respectively, for the crosslinking of the external layer 101, which comprise different crosslinking agents and activators, described hereinafter.

The aminically crosslinked AEM rubber and/or ACM rubber comprises an aminic crosslinking agent which in particular comprises a diamine, in, particular hexamethylenediamine (HMD), hexamethylenediamine carbamate (HMDC) and/or 2,2-bis[4-(4-aminophenoxy)phenyl]propene. The proportion of the aminic crosslinking agent in the barrier layer 105 is in particular from 0.3% by weight to 2.1 % by weight, in particular from 0.4% by weight to 1.5% by weight, in particular from 0.5% by weight to 1.0% by weight.

The aminically crosslinked AEM rubber and/or ACM rubber further comprises a basic activator, in particular diphenylguanidine (DPG) and/or diazabicycloundecene (DBU). The proportion of the basic activator in the barrier layer 105 is in particular from 0.5% by weight to 3.5% by weight, in particular from (15% by weight to 2.4% by weight, in particular from 0.7% by weight to 2.0% by weight.

The peroxidically crosslinked ethylene-acrylate rubber (AEM) and/or the peroxidically crosslinked polyacrylate rubber (ACM) comprises a peroxidic crosslinking agent which in particular comprises a peroxide derivative, a co-activator, and/or an acid acceptor. The peroxide derivative comprises in particular an alkyl-aralkyl peroxide derivative, a diaralkyl peroxide derivative, a peroxyketal derivative and/or a peroxyester derivative. The co-activator comprises in particular triallyl cyanurate (TAC), triallyl isocyanurate (TAIC), trimethylolpropane trimethacrylate (TRIM), dimethyl acrylate, trimethyl acrylate, triazine, and/or bismaleimide. The acid acceptor in particular comprises epoxy resins, epoxidized oils, magnesium oxide and/or hydrotalcite.

The reinforcement system 103 is in this case in particular in direct contact with the barrier layer 105 and with the external layer 101 of the fluid line 100, and in this case there is in particular an adhesive bond formed here.

In particular, the fluid line 100 can be an injection moulding or an extruded moulding. The barrier layer 105 and the external layer 101 can in this case in particular be extruded in separate extrusion steps.

The fluid line 100 consisting of three layers 101, 103, 105 is therefore configured as a low-cost fluid line 100 which exhibits effective chemical resistance and mechanical stability in relation to a fluid conducted through the internal passage 107 and in relation to exterior influences. A fluid line 100 consisting of three layers 101, 103, 105 can be produced in manufacturing plants conventionally used for three-layer production.

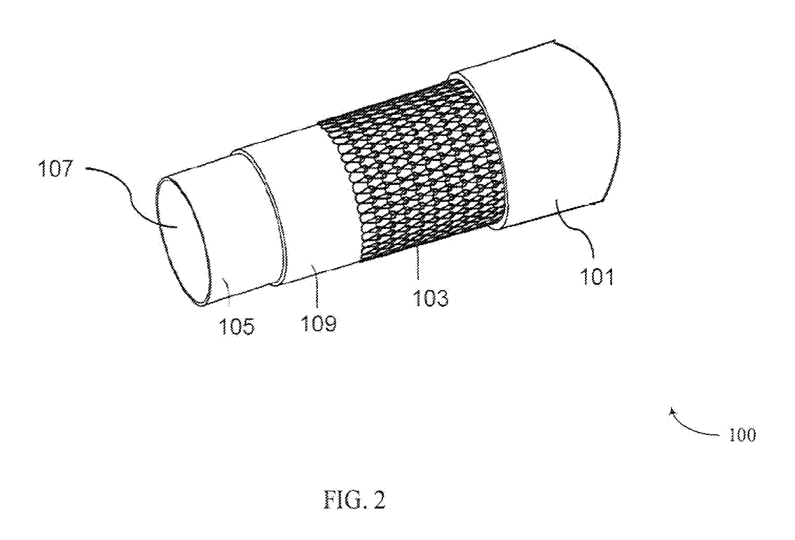

FIG. 2 is a perspective view of a fluid line according to a second example.

The fluid line 100 comprises an external layer 101 made of a crosslinked chlorinated polyethylene (CPE). The fluid line 100 comprises a reinforcement system 103, arranged within the external layer 101. The fluid line 100 comprises a barrier layer 105, arranged within the reinforcement system 103 and delimiting an internal passage 107 of the fluid line 100, where the internal passage 107 is configured to conduct fluid through the internal passage 107.

In respect of the preferred constituents of the external layer 101, of the reinforcement system 103 and of the barrier layer 105, reference is made to the statements referring to the first example according to FIG. 1.

The fluid line 100 further comprises an intermediate layer 109, arranged between the barrier layer 105 and the reinforcement system 103. The intermediate layer 109 comprises, as also does the external layer 101, a crosslinked chlorinated polyethylene (CPE).

The intermediate layer 109 reliably provides an effective adhesive bond between the barrier layer 105 and the reinforcement system 103.

According to a first alternative, the crosslinked chlorinated polyethylene (CPE) of the intermediate layer 109 comprises a thiazole derivative, a fatty acid amide derivative and/or an acid acceptor. The acid acceptor comprises in particular epoxy resins, epoxidized oils, magnesium oxide and/or hydrotalcite.

According to a second alternative, the crosslinked chlorinated polyethylene (CPE) of the intermediate layer 109 comprises a peroxide derivative, a co-activator, and/or an acid acceptor. The peroxide derivative in particular comprises an alkyl-aralkyl peroxide derivative, a diaralkyl peroxide derivative, a peroxyketal derivative and/or a peroxyester derivative. The co-activator in particular comprises triallyl cyanurate (TAC), triallyl isocyanurate (TAIC), trimethylolpropane trimethacrylate (TRIM), dimethyl acrylate, trimethyl acrylate, triazine, and/or bismaleimide. The acid acceptor in particular comprises epoxy resins, epoxidized oils, magnesium oxide and/or hydrotalcite.

The fluid line 100 consisting of four layers 101, 103, 105, 109 is therefore configured as a low-cost fluid line 100 which has effective chemical resistance and mechanical stability in relation to a fluid conducted through the internal passage 107 and in relation to exterior influences. A fluid line 100 consisting of four layers 101, 103, 105, 109 reliably provides particularly effective adhesion between the barrier layer 105 and the reinforcement system 103 within the fluid line 100.

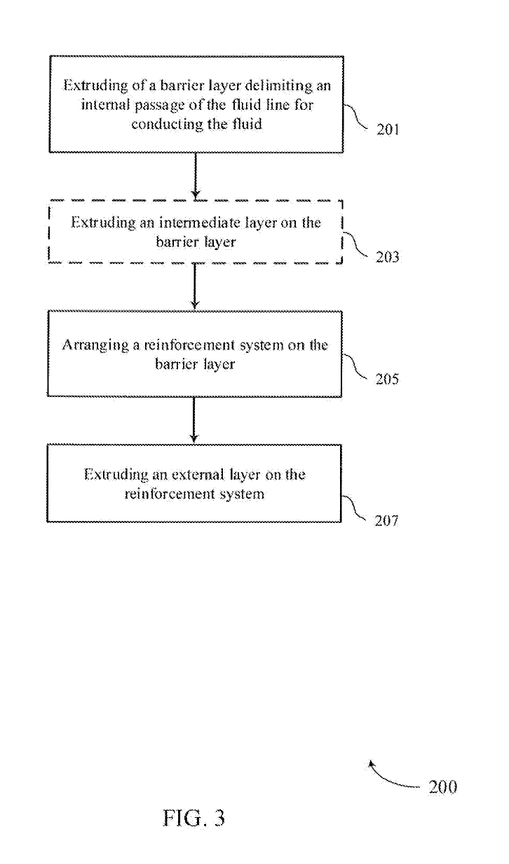

FIG. 3 is a schematic diagram of a process for the production of a fluid line.

In the case of a three-layer fluid line 100, the process 200 comprises, as first step, extruding 201 of a barrier layer 105 delimiting an internal passage 107 of the fluid line 100 for conducting the fluid, where the barrier layer 105 is configured to reduce diffusion of the fluid through the barrier layer 105; the process 200 comprises, as further step, arranging 205 a reinforcement system 103 on the barrier layer 105, and the process comprises, as further step, extruding 207 an external layer 101 on the reinforcement system 103, where the external layer 101 comprises a crosslinked chlorinated polyethylene (CPE).

In the case of a four-layer fluid line 100, the process 200 comprises, as first step, extruding 201 a barrier layer 105 delimiting an internal passage 107 of the fluid line 100 for conducting the fluid, where the barrier layer 105 is configured to reduce diffusion of the fluid through the barrier layer 105; the process 200 comprises, as further step, extruding 203 an intermediate layer 109 on the barrier layer 105; the process 200 comprises, as further step, arranging 205 a reinforcement system 103 on the intermediate layer 109, and the process 200 comprises, as further step, extruding 207 an external layer 101 on the reinforcement system 103, where the external layer 101 comprises a crosslinked chlorinated polyethylene (CPE).

The process 200 for producing a four-layer fluid line 100 therefore differs from the process 200 for producing a three-layer fluid line 100 only in that in the case of the process 200 for producing a four-layer fluid line 100 after extruding 201 of the barrier layer 105 the intermediate layer 109 is extruded 203 on the barrier layer 105 before, in a further step, the reinforcement system is arranged.

It is in particular possible here that the extrusion 201 of the barrier layer 105 and the extrusion 203 of the intermediate layer 109 are carried out as separate extrusion steps 201, 203, or together as a single co-extrusion step 201, 203.

All of the features explained and revealed in connection with individual examples of the disclosure can be provided in various combinations in the subject matter of the disclosure, in order that the advantageous effects thereof are realized simultaneously.

The scope of protection of the present disclosure is defined by the claims, and is not restricted by the features explained in the description or revealed in the figures.

### LIST OF REFERENCE NUMBERS

100 Fluid line
301 External layer
103 Reinforcement system
105 Barrier layer
107 Internal passage
109 Intermediate layer
200 Process for producing a fluid line
201 First step: extruding a barrier layer
203 Second step: extruding an intermediate layer
205 Third step: applying a reinforcement system
207 Fourth step: extruding an external layer

What is claimed is:

1. A fluid line for conducting a fluid, comprising:
an external layer comprising a crosslinked chlorinated polyethylene (CPE);
a reinforcement system arranged within the external layer; and
a barrier layer arranged within the reinforcement system and configured to delimit an internal passage of the fluid line configured to conduct the fluid, wherein the barrier layer is configured to reduce diffusion of the fluid through the barrier layer.

2. The fluid line according to claim 1, wherein the fluid line comprises an intermediate layer arranged between the barrier layer and the reinforcement system.

3. The fluid line according to claim 2, wherein the intermediate layer comprises the crosslinked CPE.

4. The fluid line according to claim 1, wherein the barrier layer comprises an aminically crosslinked ethylene-acrylate rubber (AEM), an aminically crosslinked polyacrylate rubber (ACM), or a combination thereof, wherein the aminically crosslinked AEM rubber, or the aminically crosslinked ACM rubber comprises a diamine and a basic activator.

5. The fluid line according to claim 4, wherein the diamine comprises hexamethylenediamine (HMD), hexamethylenediamine carbamate (HMDC), 2,2-bis[4-(4-aminophenoxy)phenyl]propene, or some combination thereof, and wherein the basic activator comprises diphenylguanidine (DPG), diazabicycloundecene (DBU), or a combination thereof.

6. The fluid line according to claim 1, wherein the barrier layer comprises a peroxidically crosslinked ethylene-acrylate rubber (AEM), a peroxidically crosslinked polyacrylate rubber (ACM), or a combination thereof, wherein the peroxidically crosslinked AEM rubber or the peroxidically crosslinked ACM rubber comprises a peroxide derivative, a co-activator, or an acid acceptor.

7. The fluid line according to claim 6, wherein the peroxide derivative comprises an alkyl-aralkyl peroxide derivative, a diaralkyl peroxide derivative, a peroxyketal derivative, or a peroxyester derivative, and wherein the activator comprises triallyl cyanurate (TAC), triallyl isocyanurate (TAIC), trimethylolpropane trimethacrylate (TRIM), dimethyl acrylate, trimethyl acrylate, triazine, or bismaleimide, and wherein the acid acceptor comprises epoxy resins, epoxidized oils, magnesium oxide or hydrotalcite.

8. The fluid line according to claim 1, wherein the external layer or the intermediate layer made of crosslinked CPE comprises a thiazole derivative, a fatty acid amide derivative or an acid acceptor, and wherein the acid acceptor comprises epoxy resins, epoxidized oils, magnesium oxide, or hydrotalcite.

9. The fluid line according to claim 1, wherein the external layer or the intermediate layer comprises a peroxidically crosslinked CPE, wherein the peroxidically crosslinked CPE comprises a peroxide derivative, a co-activator, or an acid acceptor, wherein the peroxide derivative comprises an alkyl-aralkyl peroxide derivative, a diaralkyl peroxide derivative, a peroxyketal derivative, or a peroxyester derivative, wherein the activator comprises triallyl cyanurate (TAC), triallyl isocyanurate (TAIC), trimethylolpropane trimethacrylate (TRIM), dimethyl acrylate, trimethyl acrylate, triazine, or bismaleimide, and wherein the acid acceptor comprises epoxy resins, epoxidized oils, magnesium oxide, or hydrotalcite.

10. The fluid line according to claim 9, wherein the peroxide derivative comprises an alkyl-aralkyl peroxide derivative, a diaralkyl peroxide derivative, a peroxyketal derivative, or a peroxyester derivative, wherein the activator comprises triallyl cyanurate (TAC), triallyl isocyanurate (TAIC), trimethylolpropane trimethacrylate (TRIM), dimethyl acrylate, trimethyl acrylate, triazine, or bismaleimide, and wherein the acid acceptor comprises epoxy resins, epoxidized oils, magnesium, oxide, or hydrotalcite.

11. The fluid line according to claim 1, wherein, the reinforcement system comprises aromatic fibres, aliphatic polyamide fibres, polyoxadiazole fibres, polyester fibres, meta-aramid fibres, para-aramid fibres, polyimide fibres, polyvinyl acetal fibres, polyetheretherketone fibres, or some mixture thereof.

12. The fluid line according to claim 11, wherein the reinforcement system is configured as a single-ply or multiple-ply reinforcement system, and wherein the reinforcement system comprises a woven fabric, a formed-loop knitted fabric, a drawn-loop knitted fabric, or some combination thereof.

13. The fluid line according to claim 1, wherein the fluid line is configured as a dimensionally stable moulded hose.

14. The fluid line according to claim 13, wherein the moulded hose comprises a two-dimensionally or three-dimensionally curved shape.

15. The fluid line according to claim 13, wherein the dimensionally stable moulded hose comprises a thickening bead on an internal side of the barrier layer, wherein the internal side faces towards the internal passage of the fluid line, and wherein the thickening bead extends around the internal side of the barrier layer.

16. The fluid line according to claim 1, wherein the fluid line is an injection moulding or an extruded moulding.

17. A process for producing a fluid line for conducting a fluid, comprising:
extruding a barrier layer that delimits an internal passage of the fluid line for conducting the fluid, wherein the barrier layer is configured to reduce diffusion of the fluid through the barrier layer;
arranging a reinforcement system on the barrier layer; and
extruding an external layer on the reinforcement system, wherein the external layer comprises a crosslinked chlorinated polyethylene (CPE).

18. The process according to claim 17, further comprising:
extruding an intermediate layer on the barrier layer;
arranging the reinforcement system on the intermediate layer; and
wherein the extrusion of the barrier layer and the extrusion of the intermediate layer are carried out as separate extrusion steps or together as a single co-extrusion step.

19. The process according to claim 18, wherein the intermediate layer comprises the crosslinked CPE.

20. The process according to claim 17, wherein the barrier layer comprises an aminically crosslinked ethylene-acrylate rubber (AEM), an aminically crosslinked polyacrylate rubber (ACM), or a combination thereof, wherein the aminically crosslinked AEM rubber, or the aminically crosslinked ACM rubber comprises a diamine and a basic activator.
